(19) United States
(12) Patent Application Publication
(10) Pub. No.: US 2005/0006236 A1
(43) Pub. Date: Jan. 13, 2005

(54) Gas sensor

(76) Inventors: Jong-Wook Kim, Seongnam (KR); Hyung-Ki Hong, Anyang (KR)

Correspondence Address: BIRCH STEWART KOLASCH & BIRCH, PO BOX 747, FALLS CHURCH, VA, 22040-0747, US

(21) Appl. No.: 10/882,227

(22) Filed: Jul. 2, 2004

(30) Foreign Application Priority Data
Jul. 7, 2003 (KR) 10-2003-0045799

(51) Int. Cl. G01N 27/26

(52) U.S. Cl. 204/415; 204/424

(57) ABSTRACT

Disclosed is a gas sensor which has high sensitivity, a short response time, and a small size and consumes a small amount of power and can be mass-produced by forming a resistor thin film and a ceramic carrier thin film absorbing CO₂ on a membrane layer having small heat capacity. The gas sensor includes a reference sensor hermetically sealed; and a sensing sensor exposed to external air. Here, the reference sensor and the sensing sensor include, respectively, a membrane layer formed on a silicon substrate and a resistor thin film formed on the membrane layer.

### BACKGROUND OF THE INVENTION

1. Field of the Invention

The present invention relates to a gas sensor, and particularly, to a sensing sensor for sensing CO₂.

2. Description of the Background Art

In general, a CO₂ sensing sensor is used for various purposes such as plant growth, microorganism culture, exhaust gas analysis, cold storage or the like.

As a CO₂ sensor, an electrolyte type sensor that detects a voltage or a current generated between electrodes through an electrochemical reaction between the electrodes in electrolyte according to the density of CO₂; an optical sensor using a principle that CO₂ absorbs light having an infrared wavelength of 4.24 μm; or a heat transfer type sensor using a temperature change of a heating element due to a thermal conductivity difference of gas, is mainly being used.

Of these three sensors, the heat-transfer type sensor using two heating elements is being generally used as a CO₂ sensor for food fermentation or vegetable growth.

Because the heat-transfer type sensor is not affected by a temperature change therearound, it can reliably detect the density of CO₂.

FIG. 1 is a sectional view showing a structure of a heat transfer type sensor in accordance with the conventional art.

As shown in FIG. 1, the heat transfer type sensor includes: a pair of carriers 11, 13 each mounted with coiled heater; pins 17-20 connected to the carriers 11, 13 through conducting wires 12, 14, penetrating a circuit board 16, for lifting the pair of carriers 11, 13; and a metal protective case 15 packaged on the circuit board 16 in order to isolate the carriers 11, 13 from the outside and having a fine hole 10 for exposing one carrier 11 to the air. Here, one carrier 11 is in contact with CO₂ in the air through the hole of the case 15, and the other carrier 13 is sealed in the case 15. As for the other carrier 13, the sealed space where the other carrier 13 is installed is filled with N₂ so that the surface of the carrier 13 is not exposed to CO₂.

Accordingly, if a bridge circuit is constructed with the pair of carriers 11, 13 and an external resistor, CO₂ takes heat away from one carrier 11, thereby changing a resistance value only at the exposed carrier 11, and the density of CO₂ is detected based on the resistance value.

However, the conventional heat-transfer type sensor has low sensitivity and a long response time because it uses a coiled heater and a ceramic carrier as a sensing sensor and thus its heat capacity is great.

In addition, because the carriers 11, 13 are lifted up by using the conducting wires and the pins, and the metal conducting wires and the pins are spot-welded, its fabrication process is complex and the number of processes are increased, which make the heat-transfer sensor expensive and inappropriate for mass production.

### SUMMARY OF THE INVENTION

Therefore, an object of the present invention is to provide a gas sensor having high sensitivity and a short response time by forming a resistor thin film and a ceramic carrier thin film absorbing CO₂ on a membrane layer having small heat capacity.

Another object of the present invention is to provide a gas sensor consuming a small amount of power and having a small size by forming a resistor thin film and a ceramic carrier thin film having micro sizes.

Another object of the present invention is to provide a gas sensor which can be mass-produced by using a silicon substrate.

To achieve these and other advantages and in accordance with the purpose of the present invention, as embodied and broadly described herein, there is provided a gas sensor comprising: a reference sensor hermetically sealed; and a sensing sensor exposed to external air, wherein the reference sensor and the sensing sensor respectively include, a membrane layer formed on a silicon substrate; and a resistor thin film formed on the membrane layer.

To achieve these and other advantages and in accordance with the purpose of the present invention, as embodied and broadly described herein, there is provided a gas sensor comprising: a reference sensor hermetically sealed; and a sensing sensor exposed to external air, wherein the reference sensor and the sensing sensor respectively include: a membrane layer formed on a silicon substrate; a resistor thin film formed on the membrane layer; a ceramic carrier thin film encompassing a part of a pattern of the resistor thin film; metal pads formed on parts of the resistor thin film and electrically connected to the resistor thin film; a shielding case separating the sensing sensor and the reference sensor from each other; pins electrically connected to the metal pads through a wire and protruding from a lower surface of the shielding case; and a cover having a hole for exposing the sensing sensor to external air and sealing an upper surface of the shielding case so as not to expose the reference sensor to the external air.

To achieve these and other advantages and in accordance with the purpose of the present invention, as embodied and broadly described herein, there is provided a gas sensor comprising: a reference sensor hermetically sealed; and a sensing sensor exposed to external air, wherein the reference sensor and the sensing sensor respectively include: a membrane layer formed on a silicon substrate; a resistor thin film formed on the membrane layer; a ceramic carrier thin film encompassing a part of a pattern of the resistor thin film; and metal pads formed on parts of the resistor thin film and electrically connected to the resistor thin film.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a sectional view showing a structure of a heat-transfer sensor in accordance with the conventional art;

FIG. 2 is a sectional view showing a sensing sensor and a reference sensor of a gas sensor for sensing carbon dioxide (CO₂) in accordance with the present invention;

FIG. 3 is a sectional view a structure that a sensing sensor and a reference sensor of a gas sensor for sensing CO₂ are packaged; and

FIG. 4 is an exemplary view showing a construction of a sensing circuit which

### DETAILED DESCRIPTION OF THE PREFERRED EMBODIMENTS

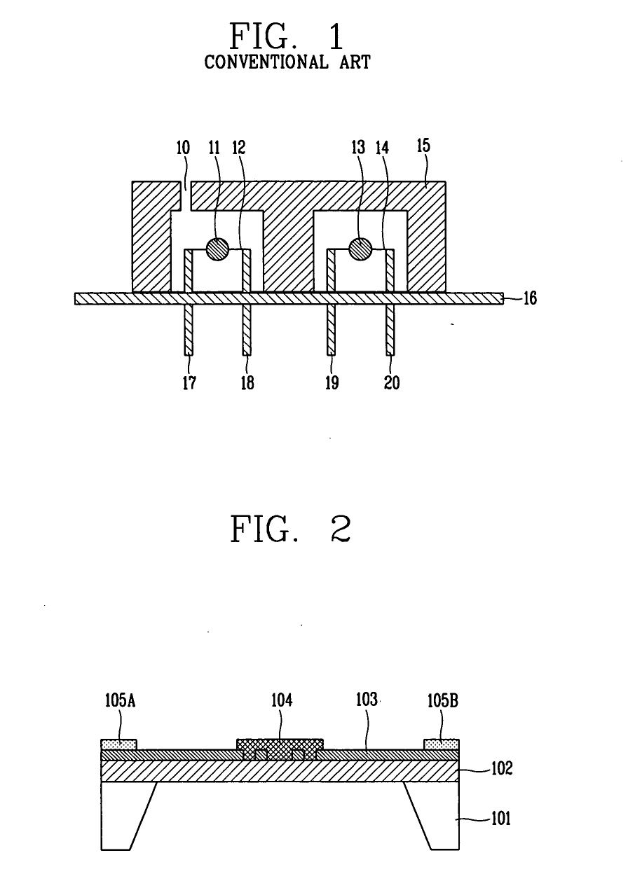

Hereinafter, a preferred embodiment of a gas sensor which has high sensitivity, a short response time and a small size, consumes a small amount of power and can be mass-produced by forming a resistor thin film and a ceramic carrier thin film absorbing CO₂ on a membrane layer having small heat capacity, will now be described with reference to FIGS. 2 to 4.

FIG. 2 is a sectional view showing a sensing sensor and a reference sensor of a gas sensor for sensing carbon dioxide (CO₂) in accordance with the present invention. Here, the sensing sensor and the reference sensor has the same structure.

As shown therein, a gas sensor in accordance with the present invention includes a sensing sensor and a reference sensor. The sensing sensor 100A and the reference sensor 100B include, respectively, a silicon substrate 101; a membrane layer 102 formed on the silicon substrate 101; a resistor thin film 103 formed on the membrane layer 102; a ceramic carrier thin film 104 encompassing a part of a pattern of the resistor thin film 103; and metal pads 105A, 105B formed on parts of the resistor thin film 103 and electrically connected to the resistor thin film 103. The reference sensor 100B is hermetically sealed, and the sensing sensor 100A is exposed to external air. The silicon substrate 101 formed at a part of a lower surface of the membrane layer 102 is removed through an etching process, thereby levitating a part of the membrane layer 102. Here, the resistor thin film 103 functioning as a coiled heater and having a temperature coefficient of resistance and a ceramic carrier thin film 104 absorbing CO₂ gas are formed on the membrane layer 102 by using a general micromachining technology.

As the membrane layer 102, one selected from a stacked layer formed of SiO₂/Si₃N₄/SiO₂, a Si₃N₄ layer and SiOₓN_{y} layer having a low stress characteristic is preferably used.

The resistor thin film 103 is preferably made of one selected from RuO₂, Ti and Pt having a temperature coefficient of resistant.

The ceramic carrier thin film 104 is preferably made of one selected from Al₂O₃, ZrO₂, LiTiO₃ and Lithium silicate which absorb CO₂ gas. Here, CO₂ can be sensed without the ceramic carrier thin film 104 encompassing a part of a pattern of the resistor thin film 103, but the ceramic carrier thin film 104 is preferably formed on the part of the pattern of the resistor thin film 103 in order to improve sensitivity of the gas sensor by improving absorptivity of CO₂. In addition, if a part of the resistor film 103 is etched to be removed, and the ceramic carrier thin film 104 is formed at a position where the part of the resistor thin film 103 has been removed, then the ceramic carrier thin film 104 adheres to the resistor thin film well.

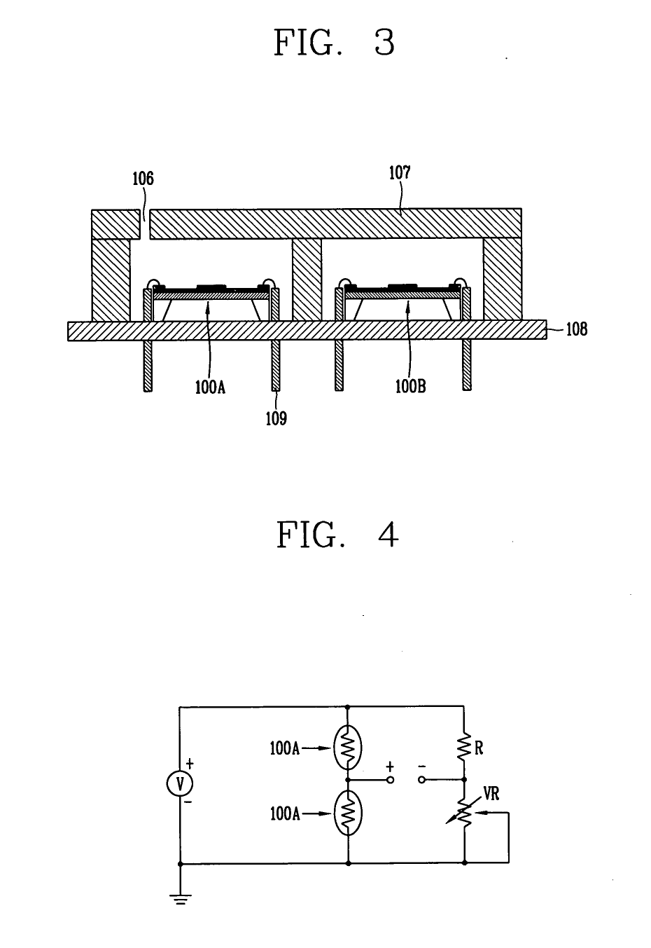

The gas sensor for sensing CO₂ in accordance with the present invention can detect CO₂ only upon packaging the sensing sensor 100A and the reference sensor 100b which is not affected by the change of surroundings. Accordingly, a structure of a gas sensor in which the sensing sensor 100A and the reference sensor 100B are packaged together will now be described in detail with reference to FIG. 3.

FIG. 3 is a sectional view showing a structure that a sensing sensor 100A and a reference sensor 100B of a gas sensor for sensing CO₂ gas are packaged in accordance with the present invention.

As shown therein, the gas sensor includes a shielding case 108; a sensing sensor 100A and a reference sensor 100B attached to the shielding case 108 and separated from each other by the shielding case 108; pins 109 electrically connected to metal pads 105A, 105B of the sensing sensor 100A and the reference sensor 100B through a wire and protruding from a lower surface of the shielding case 108; and a cover 107 having a hole 106 for exposing the sensing sensor 100A to external air and sealing an upper surface of the shield case so as not to expose the reference sensor 100B to the external air.

The sensing sensor 100A is in contact with external CO₂ through the hole of the cover 107. The reference sensor 100B is sealed, and the sealed space where the reference sensor 100B is installed is filled with N₂.

FIG. 4 is an exemplary view showing a structure of a sensing circuit which may be used for a gas sensor in accordance with the present invention. That is, when the density of gas such as CO₂ is changed, a temperature of a sensing sensor 100A is changed due to CO₂ absorbed by a ceramic carrier thin film 104 and a resistor thin film 103, and, by such a temperature change, a resistance value of the resistor thin film 103 of the sensing sensor is changed. Accordingly, the density of CO₂ can be measured by measuring a potential difference (positive (+), negative (−) terminal) generated at the sensing circuit according to the change of the resistance value of the resistor thin film 103. Here, the resistance value of the gas sensor may be measured through various methods and devices.

Hereinafter, a method for detecting the density of CO₂ generated when Kimchi (traditional Korean side dish) ferments and its fermentation level by using the gas sensor and the sensing circuit in accordance with the present invention, will now be described as an example.

First, when Kimchi ferments in a Kimchi refrigerator, CO₂ is generated, and the generated CO₂ is introduced into a package in which the sensing sensor 100A is positioned through the hole 106 formed at the shield case 108 of the gas sensor. Then, the introduced CO₂ comes in contact with the sensing sensor 100A which has been self-heated by a bias power (V), thereby taking heat away from the sensing sensor 100A. At this time, heat loss is made at the sensing sensor 100A, and its temperature is lowered, corresponding to the heat loss, thereby lowering a temperature of the resistor thin film 103 of the sensing sensor 100A. That is, as a temperature of the resistor thin film 103 is lowered, a resistance value of the resistor thin film 103 is changed. And as the resistance value of the resistor thin film 103 is changed, an output value of a bridge circuit (sensing circuit) is changed, and, based on the changed value, the density of CO₂ is detected.

Accordingly, the density of CO₂ around the gas sensor can be easily sensed through the CO₂ sensing sensor and the sensing circuit. Said gas sensor may be used for a Kimchi refrigerator which can automatically control a fermentation level of Kimchi by detecting the density of CO₂ generated when Kimchi ferments.

As so far described, in the present invention, because a resistor thin film and a ceramic carrier thin film for absorbing CO₂ is formed on a membrane layer by using a micromachining technology, small heat capacity of a gas sensor can be obtained, thus, sensitivity of the gas sensor can be improved by making a temperature change of a sensing sensor due to CO₂ generation large, and a thin film type gas sensor having a short response time can be implemented.

In addition, in the present invention, a gas-sensing unit can be formed small and assembled through a simple process by conducting a silicon process so that the gas sensor can be mass-produced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A gas sensor comprising:
a reference sensor hermetically sealed; and
a sensing sensor exposed to external air,
wherein the reference sensor and the sensing sensor respectively comprise: a membrane layer formed on a silicon substrate; and a resistor thin film formed on the membrane layer.

2. The gas sensor of claim 1, further comprising a ceramic carrier thin film encompassing a part of a pattern of the resistor thin film.

3. The gas sensor of claim 1, wherein the gas sensor is installed in a Kimchi refrigerator.

4. The gas sensor of claim 1, wherein a part of the membrane layer is levitated by removing a part of the silicon substrate.

5. The gas sensor of claim 1, further comprising:
metal pads formed on parts of the resistor thin film and electrically connected to the resistor thin film.

6. The gas sensor of claim 5, further comprising:
a shielding case;
pins electrically connected to the metal pads through a wire and protruding from a lower surface of the shielding case; and
a cover having a hole for exposing the sensing sensor to external air and hermetically sealing an upper surface of the shielding case so as not to expose the reference sensor to the external air,
wherein the sensing sensor and the reference sensor are attached to the shielding case and separated from each other by the shielding case.

7. The gas sensor of claim 6, wherein the sensing sensor is in contact with external CO₂ through the hole of the cover, and the reference sensor is hermetically sealed.

8. The gas sensor of claim 1, wherein the membrane layer is one selected from a stacked layer formed of SiO₂/Si₃N₄/SiO₂, a Si₃N₄ layer and SiOₓN_{y} layer.

9. The gas sensor of claim 1, wherein the resistor thin film is made of one selected from RuO₂, Ti and Pt.

10. The gas sensor of claim 1, wherein the ceramic carrier thin film is made of one selected from Al₂O₃, ZrO₂, LiTiO₃ and Lithium silicate.

11. The gas sensor of claim 1, wherein the sensing sensor senses CO₂.

12. A gas sensor comprising:
a reference sensor hermetically sealed; and
a sensing sensor exposed to external air,
wherein the reference sensor and the sensing sensor respectively comprise:
a membrane layer formed on a silicon substrate;
a resistor thin film formed on the membrane layer;
a ceramic carrier thin film encompassing a part of a pattern of the resistor thin film;
metal pads formed on parts of the resistor thin film and electrically connected to the resistor thin film;
a shielding case separating the sensing sensor and the reference sensor from each other;
pins electrically connected to the metal pads through a wire and protruding from a lower surface of the shielding case; and
a cover having a hole for exposing the sensing sensor to external air and sealing an upper surface of the shielding case so as not to expose the reference sensor to the external air.

13. The gas sensor of claim 12, wherein the gas sensor is installed in a Kimchi refrigerator.

14. The gas sensor of claim 12, wherein a part of the membrane layer is levitated by removing a part of the silicon substrate.

15. The gas sensor of claim 12, wherein the sensing sensor is in contact with CO₂ through the hole of the cover, and the reference sensor is hermetically sealed.

16. The gas sensor of claim 12, wherein the membrane layer is one selected from a stacked layer formed of SiO₂/Si₃N₄/SiO₂, a Si₃N₄ layer and SiOₓN_{y}.

17. The gas sensor of claim 12, wherein the resistor thin film is made of one selected from RuO₂, Ti and Pt.

18. The gas sensor of claim 12, wherein the ceramic carrier thin film is made of one selected from Al₂O₃, ZrO₂, LiTiO₃ and Lithium silicate.

19. The gas sensor of claim 12, wherein the sensing sensor senses CO₂.

20. A gas sensor comprising:
a reference sensor hermetically sealed; and
a sensing sensor exposed to external air,
wherein the reference sensor and the sensing sensor respectively comprise:
a membrane layer formed on a silicon substrate;
a resistor thin film formed on the membrane layer;
a ceramic carrier thin film encompassing a part of a pattern of the resistor thin film; and
metal pads formed on parts of the resistor thin film and electrically connected to the resistor thin film.
